(19) United States
(12) Patent Application Publication
(10) Pub. No.: US 2023/0387474 A1
(43) Pub. Date: Nov. 30, 2023

(54) BATTERY MANUFACTURING METHOD, BATTERY, AND LAMINATED BATTERY

(71) Applicant: Panasonic Intellectual Property Management Co., Ltd., Osaka (JP)

(72) Inventor: Eiichi KOGA, Osaka (JP)

(21) Appl. No.: 18/447,924

(22) Filed: Aug. 10, 2023

Related U.S. Application Data
(63) Continuation of application No. PCT/JP2021/043494, filed on Nov. 26, 2021.

(30) Foreign Application Priority Data
Feb. 19, 2021 (JP) 2021-025698

(51) Int. Cl. H01M 10/0585; H01M 4/04; H01M 4/36

(52) U.S. Cl. CPC H01M 10/0585; H01M 4/0404; H01M 4/366

(57) ABSTRACT

A manufacturing method of the present disclosure includes (A) obtaining a battery by cutting a long laminate in a lamination direction, the laminate including a first active material layer, a solid electrolyte layer, and a second active material layer that are disposed in this order. The laminate has a first region and a second region that are repeated alternately in a lengthwise direction, where the first active material layer is present in the first region and is not present in the second region in plan view in the lamination direction. In the (A), the laminate is cut in the first region and the second region so that the battery has a desired capacity.

This application is a continuation of PCT/JP2021/043494 filed on Nov. 26, 2021, which claims foreign priority of Japanese Patent Application No. 2021-025698 filed on Feb. 19, 2021, the entire contents of both of which are incorporated herein by reference.

The present disclosure relates to a battery manufacturing method, a battery, and a laminated battery.

### BACKGROUND OF THE INVENTION

### 1. Field of the Invention

Techniques for accurately manufacturing a battery have been conventionally proposed. For example, JP 2015-106442 A discloses an electrode manufacturing method by which, in the electrode manufacturing by cutting an electrode material obtained by coating a strip-shaped metal foil with an active material, a shift in cutting position of the electrode material can be suppressed. JP 2019-102196 A proposes a battery manufacturing technique by which a battery can be accurately manufactured so as not to cause a short circuit and the material yield is also enhanced. Specifically, JP 2019-102196 A discloses a manufacturing method of intermittently coating a strip-shaped current collector with an active material layer, cutting the current collector in an uncoated portion of the active material layer, and using the uncoated portion as the current collector tab.

### 2. Description of Related Art

### SUMMARY OF THE INVENTION

The present disclosure aims to provide a battery manufacturing method capable of accurately manufacturing a battery having a target capacity.

A battery manufacturing method according to an aspect of the present disclosure including (A) obtaining a battery by cutting a long laminate in a lamination direction, the laminate including a first active material layer, a solid electrolyte layer, and a second active material layer that are disposed in this order, wherein the laminate has a first region and a second region that are repeated alternately in a lengthwise direction, where the first active material layer is present in the first region and is not present in the second region in plan view in the lamination direction, and in the (A), the laminate is cut in the first region and the second region so that the battery has a desired capacity.

The present disclosure provides a battery manufacturing method capable of accurately manufacturing a battery having a target capacity.

### BRIEF DESCRIPTION OF THE DRAWINGS

FIG. 1A is a cross-sectional view showing a laminate 2000 in a manufacturing method according to Embodiment 1.

FIG. 1B is a plan view showing the laminate 2000 in the manufacturing method according to Embodiment 1, as viewed in plan in the lamination direction.

FIG. 2A is an enlarged plan view showing Modification 1 of the laminate 2000 in the manufacturing method according to Embodiment 1, as viewed in the lamination direction.

FIG. 2B is a cross-sectional view taken along line II-II in FIG. 2A.

FIG. 3A is an enlarged plan view showing Modification 2 of the laminate 2000 in the manufacturing method according to Embodiment 1, as viewed in the lamination direction.

FIG. 3B is a cross-sectional view taken along line III-Ill in FIG. 3A.

FIG. 4A is an enlarged plan view showing Modification 3 of the laminate 2000 in the manufacturing method according to Embodiment 1, as viewed in the lamination direction.

FIG. 4B is a cross-sectional view taken along line IV-IV in FIG. 4A.

FIG. 5A is a schematic cross-sectional view showing the configuration of a battery 3000 according to Embodiment 2, as viewed in the lengthwise direction.

FIG. 5B is a side view showing a first side surface 38 of the battery 3000 according to Embodiment 2.

FIG. 5C is a side view showing a second side surface 39 of the battery 3000 according to Embodiment 2.

FIG. 6 is a cross-sectional view showing a battery 3000A according to Modification 1 of the battery 3000 according to Embodiment 2, as viewed in the lengthwise direction.

FIG. 7 is a cross-sectional view showing a battery 3000B according to Modification 2 of the battery 3000 according to Embodiment 2, as viewed in the lengthwise direction.

FIG. 8 is a schematic cross-sectional view showing the configuration of a laminated battery 3100 according to Embodiment 3.

FIG. 9 is a schematic cross-sectional view showing the configuration of a laminated battery 3200 according to Embodiment 4.

### DETAILED DESCRIPTION

Embodiments of the present disclosure will be specifically described below with reference to the drawings.

The embodiments to be described below each illustrate a generic or specific example. The numerical values, shapes, materials, constituent elements, arrangement positions of the constituent elements, and manners of connection of the constituent elements, etc. which will be indicated in the embodiments below are only illustrative, and are not intended to limit the present disclosure.

Moreover, the drawings are not necessarily strict. In the drawings, substantially identical constituent elements are assigned with the same reference numerals, and redundant description thereof will be omitted or simplified.

In the present specification and drawings, the x axis, the y axis, and the z axis indicate the three axes in a three-dimensional orthogonal coordinate system. In the embodiments, the z-axis direction is defined as the thickness direction of the laminate, the battery, and the laminated battery. Moreover, in the present specification, the “thickness direction” refers to a direction perpendicular to the plane up to which the layers are laminated.

In the present specification, the phrase “in plan view” means that the battery is viewed along the lamination direction in the laminate, the battery, and the laminated battery. In the present specification, the “thickness” refers to the length of the laminate, the battery, the laminated battery, and the layers in the lamination direction.

In the present specification, “in” and “out” in the terms “inward”, “outward”, and the like respectively indicate the inside and the outside when the laminate, the battery, and the laminated battery are respectively viewed along the lamination direction in the laminate, the battery, and the laminated battery.

In the present specification, the terms “upper” and “lower” in the battery configuration respectively do not mean being in the upward direction (vertically above) and being in the downward direction (vertically below) in the absolute spatial recognition, but are used as the terms defined by the relative positional relation based on the lamination order in the lamination structure. Moreover, the terms “upper” and “lower” are applied not only in the case where two constituent elements are disposed with a space therebetween and other constituent element is present between the two constituent elements, but also in the case where two constituent elements are disposed in close and direct contact with each other.

In the present specification, the “side surface” refers to the surface along the lamination direction, unless specifically stated otherwise.

### Embodiment 1

A battery manufacturing method according to Embodiment 1 will be described below.

The battery manufacturing method according to Embodiment 1 includes (A) obtaining a battery by cutting a long laminate in the lamination direction, the laminate including a first active material layer, a solid electrolyte layer, and a second active material layer that are disposed in this order. The laminate has a first region and a second region that are repeated alternately in the lengthwise direction. The first active material layer is present in the first region and is not present in the second region in plan view in the lamination direction. In the above (A), the laminate is cut in the first region and the second region so that the battery has a desired capacity.

Batteries generally have variations in coating amount, density, etc. of the active material depending on the processes including the coating with the active material and the lamination of the active material and the solid electrolyte in the battery manufacturing process. Consequently, the capacity of a battery to be manufactured is not stable, so that it is difficult to accurately manufacture a battery having a target capacity. For example, in the manufacturing method described in JP 2015-106442 A described in 2. Description of Related Art, the pressing mechanism suppresses a shift in cutting position due to deflection of the electrode material caused by stress of the cutting mechanism. Accordingly, the manufacturing method described in JP 2015-106442 A is not a method for suppressing variation in capacity of the battery caused by variations in coating amount, density, etc. of the active material, and thus is not sufficient as a technique for manufacturing a battery with high accuracy of the capacity. The manufacturing method described in JP 2019-102196 A includes, with respect to a current collector having a coated portion that is coated with an active material layer and an uncoated portion that is not coated with the active material layer, cutting the current collector in the uncoated portion. However, the manufacturing method described in JP 2019-102196 A is a method for preventing a short circuit of the battery, and is not a method for suppressing variation in capacity of the battery caused by variations in coating amount, density, etc. of the active material. Accordingly, the manufacturing method described in JP 2019-102196 A is not sufficient as a technique for manufacturing a battery with high accuracy of the capacity. Thus, no proposal has been conventionally made on a technique for accurately manufacturing a battery having a target capacity while taking into consideration variation in capacity of the battery caused by variations in coating amount, density, etc. of the active material.

In the manufacturing method according to Embodiment 1, it is possible to adjust the capacity to any capacity by adjusting the cutting position in the first region and the cutting position in the second region. Consequently, it is possible to adjust the cutting position so that a battery to be obtained has a target capacity, while taking into consideration variation in capacity caused by variations in coating amount, density, etc. of the active material. Therefore, according to the manufacturing method according to Embodiment 1, it is possible to suppress variation in capacity caused by variations in coating amount, density, etc. of the active material, thereby obtaining a battery with high accuracy of the capacity. Moreover, it is possible to adjust the cutting position in each of the first region coated with the first active material layer and the second region coated with the first active material layer to determine an appropriate cutting position and cut the laminate. Therefore, it is possible to perform an advanced capacity adjustment with a predetermined size.

The manufacturing method according to Embodiment 1 may include:
(B) measuring the capacity of the battery obtained in the above (A); and
(C) determining the cutting position of the long laminate by comparing the capacity measured in the above (B) with the desired capacity.

According to the above method, it is possible to measure the capacity of the battery obtained by cutting the laminate in the above (A), and perform a further advanced adjustment on the cutting position of the laminate depending on the measurement results. Therefore, according to the above method, it is possible to further suppress variation in capacity of the battery caused by variations in coating amount, density, etc. of the active material. Therefore, it is possible to achieve a manufacturing method for a battery with higher accuracy of the capacity.

For example, the manufacturing method according to Embodiment 1 may further include, after the above (C),
(D) obtaining a battery by correcting the cutting position of the laminate to the cutting position determined in the above (C) and cutting the laminate in the lamination direction at the corrected cutting position in each of the first region and the second region. According to this method, it is possible to efficiently manufacture a battery with higher accuracy of the capacity.

The long laminate may further include a current collector. In the first region, the first active material layer is disposed between the current collector and the solid electrolyte layer. In the second region, the solid electrolyte layer is disposed between the current collector and the second active material layer.

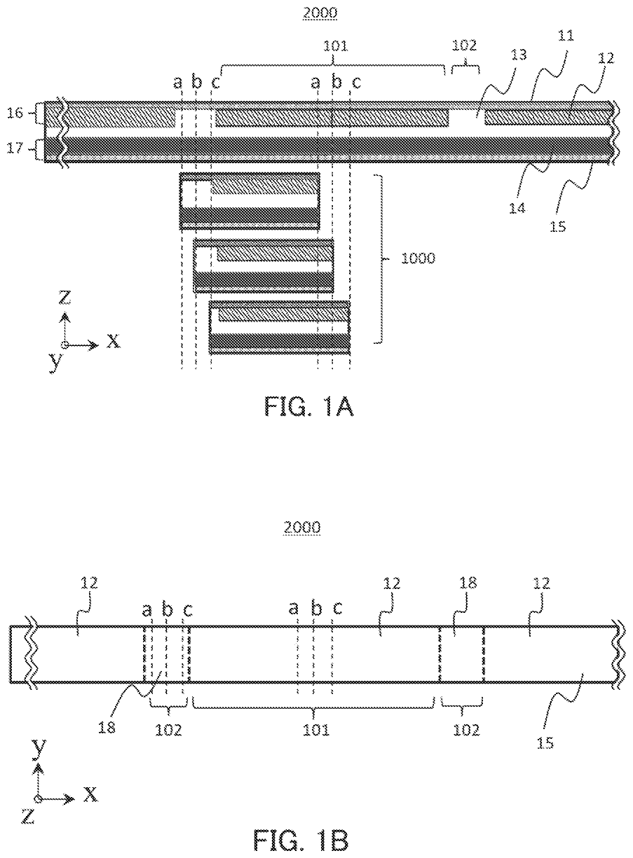

FIG. 1A is a cross-sectional view showing a laminate 2000 in a manufacturing method according to Embodiment 1. FIG. 1B is a plan view showing the laminate 2000 in the manufacturing method according to Embodiment 1, as viewed in plan in the lamination direction. The laminate 2000 shown in FIG. 1A and FIG. 1B includes a first electrode 16, a solid electrolyte layer 13, and a second electrode 17. The first electrode 16 consists of a first current collector 11 and a first active material layer 12. The second electrode 17 consists of a second current collector 15 and a second active material layer 14. Accordingly, the laminate 2000 includes the first current collector 11, the first active material layer 12, the solid electrolyte layer 13, the second active material layer 14, and the second current collector 15 in this order. The laminate 2000 is a long laminate. The laminate 2000 has a first region 101 and a second region 102 that are repeated alternately in the lengthwise direction. The first active material layer 12 is present in the first region 101 and is not present in the second region 102 in plan view in the lamination direction.

The laminate 2000 is cut in the first region 101 and the second region 102 so that the battery has a desired capacity, and thus a battery 1000 is obtained. That is, the battery 1000 is cut from the laminate 2000. For example, even in the case where the size of the battery 1000 to be cut from the laminate 2000 is set to a predetermined value, the capacity of the battery 1000 can be adjusted by adjusting the cutting positions in the first region 101 and the second region 102. FIG. 1A and FIG. 1B show an example of a case where the laminate 2000 is cut to obtain the battery 1000 having a predetermined size. In FIG. 1A and FIG. 1B, for example, zones a-a, b-b, and c-c each have a length corresponding to the length of the battery 1000. Accordingly, the symbols a, b, and c each indicate an example of the cutting position of the laminate 2000 for obtaining the battery 1000. In the examples, all the zones a-a, b-b, and c-c have the same length.

For example, by changing the cutting position from a-a, b-b, and c-c in this order, it is possible to increase the amount of the active material (i.e., the area of the first active material layer 12) without changing the length of the battery 1000. Thus, according to the manufacturing method of the present disclosure, it is possible to obtain a battery having any capacity and the same battery shape by changing the cutting position.

Moreover, by fixing the cutting position in the first region 101 and adjusting the cutting position in the second region 102, it is possible to change the length of the battery 1000 without changing the amount of the active material (i.e., the area of the first active material layer 12).

Therefore, according to the manufacturing method of the present disclosure, it is possible to achieve a manufacturing method for a battery with any size and high accuracy of the capacity.

The area of the first region 101 in plan view in the lamination direction may have linearity in the lengthwise direction of the laminate 2000. In the case where the first active material layer 12 has a shape according to which the capacity varies linearly depending on the change in cutting position, it is easy to control and predict the capacity of the battery. Therefore, it is possible to further suppress variation in capacity of the battery caused by variations in coating amount, density, etc. of the active material layer, thereby achieving a manufacturing method for a battery with high accuracy of the capacity.

In the example shown in FIG. 1B, the direction in which the first region 101 and the second region 102 are repeated is the long direction of the battery 1000. Alternatively, the first region 101 and the second region 102 may be repeated in the short direction of the battery 1000. That is, for example, in the case where the first active material layer 12 is formed by coating the long first current collector 11 with the active material, the first current collector 11 may be intermittently coated with the active material in the long direction of the battery 1000, or may be intermittently coated with the active material in the short direction of the battery 1000.

The battery 1000 may include at least a battery A and a battery B. In this case, the battery A and the battery B may have the same length and different capacities. That is, two types of batteries having the same length and different capacities may be manufactured by the manufacturing method according to the present embodiment.

The sum of the lengths of the first region 101 and the second region 102 continuous with the first region 101 in the lengthwise direction may be twice the length of the battery 1000. That is, for example, in the case where the first active material layer 12 is formed by coating the long first current collector 11 with an active material, the first current collector 11 may be intermittently coated with the active material so that the sum of the lengths in the coating direction of one coated portion and one uncoated portion continuous with the one coated portion in the lengthwise direction is twice the length of the battery 1000. The sum of the lengths of the first region 101 and the second region 102 continuous with the first region 101 in the lengthwise direction, that is, the sum of the lengths in the lengthwise direction of one first region 101 and one second region 102 that are continuous in the lengthwise direction is hereinafter referred to as “the length of the first region 101 and the second region 102”.

In the case where the length of the first region 101 and the second region 102 is twice the length of the battery 1000, it is possible to obtain two batteries having the same length and the same capacity. Moreover, it is also possible to obtain one battery having a target capacity and another battery having the same length as the length of the one battery and a different capacity from the capacity of the one battery. Therefore, in the case where the length of the first region 101 and the second region 102 is twice the length of the battery 1000, it is possible to efficiently obtain batteries having the same length.

For example, by successively cutting the laminate 2000 shown in FIG. 1A and FIG. 1B at the positions corresponding to a-a or c-c, it is possible to obtain two types of batteries having the same length and different capacities. Therefore, by adjusting the coating for the first active material layer 12 in advance, it is also possible to obtain two types of batteries having desired capacities at the same time.

By successively cutting the laminate 2000 at the positions at which the areas of the first region 101 and the second region 102 are each halved, as indicated by b-b in FIG. 1A and FIG. 1B, it is also possible to more efficiently obtain batteries having the same length and the same capacity.

In the laminate 2000 shown in FIG. 1A and FIG. 1B, the first current collector 11, the first active material layer 12, the solid electrolyte layer 13, the second active material layer 14, and the second current collector 15 each have a rectangular shape in plan view in the lamination direction. Alternatively, other shape may be employed.

The constituent elements of the laminate 2000 in the manufacturing method of Embodiment 1 will be specifically described below.

In the present specification, the first current collector 11 and the second current collector 15 are also collectively referred to simply as “collectors”.

### (Current Collectors)

The current collectors should be formed of any electrically conductive material, and are not limited to any particular material.

The current collectors each may be, for example, a foil-like, plate-like, or mesh-like current collector formed of, for example, stainless steel, nickel, aluminum, iron, titanium, copper, palladium, gold, or platinum, or an alloy of two or more of these metals. The material of the current collectors may be selected as appropriate so that the current collectors are neither melted nor decomposed in the manufacturing process, at the operating temperature, and at the operating pressure, and in consideration of the battery operation potential applied to the current collectors and the electrical conductivity. Moreover, the material of the current collectors can be selected also depending on the required tensile strength and heat resistance. The current collectors each may be, for example, a high-strength electrolytic copper foil or a cladding material composed of laminated dissimilar metal foils.

The current collectors each may have a thickness of, for example, 10 μm or more and 100 μm or less.

The current collectors each may be a current collector whose surface is processed into an uneven rough surface.

The first current collector 11 has a first surface and a second surface opposite to the first surface, and the first surface faces the first active material layer 12 or the solid electrolyte layer 13. The second current collector 15 has a first surface and a second surface opposite to the first surface, and the first surface faces the second active material layer 14. The second surface of the first current collector 11 may have an uneven structure. In the case where the second surface of the first current collector 11 has an uneven structure, the difference in image or thickness caused by the unevenness can be used as the position reference for cutting the laminate 2000. Therefore, it is possible to obtain a battery with excellent accuracy of the capacity.

The first surface of the first current collector 11 may have an uneven structure. In this case, for example, the joining properties at the interface of the current collector is reinforced, thereby enhancing the mechanical reliability, thermal reliability, and cycle characteristics of the battery 1000 to be obtained. Moreover, having the uneven structure increases the joining area thus to reduce the electrical resistance, and consequently the influence on the battery characteristics can be reduced.

### (First Active Material Layer 12)

The first active material layer 12 is formed by intermittently coating the first current collector 11 with the active material while interposing, between the coated portions, an uncoated portion 18 that is not to be coated with the active material. Thus, the laminate 2000 has the first region 101 and the second region 102 that are repeated alternately in the lengthwise direction, where the first active material layer 12 is present in the first region 101 and is not present in the second region 102 in plan view in the lamination direction.

The length of the uncoated portion 18 in the lengthwise direction leads to the range of capacity adjustment of the battery. The length of the uncoated portion 18 may be determined in view of the range of capacity variation and the lamination properties of the layers. The lamination properties of the layers refer to, for example, the joining state of the layers or the extent of removal of air bubbles in the joined portions.

The first active material layer 12, which is the portion coated with the active material, is not limited to any shape. The first active material layer 12 shown in FIG. 1B is rectangular in plan view in the lamination direction. Alternatively, the first active material layer 12 may be circular, elliptical, or the like in plan view in the lamination direction. From the viewpoint of facilitating the capacity adjustment, the first active material layer 12 may be in the shape such that the area of the first active material layer 12 in plan view in the lamination direction has linearity in the lengthwise direction of the laminate 2000.

After the coating for the first active material layer 12, the uncoated portion 18 may be coated with a solid electrolyte. That is, the solid electrolyte may be formed in the uncoated portion 18 in a reversed pattern (positive-negative relation) to the pattern of the first active material layer 12. The coating of the uncoated portion 18 with the solid electrolyte may be performed after drying of the first active material layer 12, or may be performed before the drying so that both the solid electrolyte and the first active material layer 12 are dried together. The solid electrolyte to be used may be a material such as a solid sulfide electrolyte having excellent plasticity, which is often used for all-solid-state batteries, or may be the same material as the material of the solid electrolyte layer 13. In this case, the joining strength between the first current collector 11 and the solid electrolyte layer 13 is enhanced, thereby suppressing separation of the first current collector 11. Furthermore, an effect of enhancing the joining strength between the solid electrolyte layer 13 and the first active material layer 12 is achieved. Consequently, providing the uncoated portion 18 also achieves an effect of suppressing the occurrence of a structural defect caused by expansion and contraction of the active material resulting from charge and discharge of the battery 1000 to be obtained. Therefore, it is possible to manufacture a battery having excellent reliability.

The first active material layer 12 and the uncoated portion 18 can be confirmed from the side surface of the laminate 2000 along the lengthwise direction. Consequently, it is also possible to determine the cutting position of the laminate 2000 for obtaining the battery 1000. Moreover, the observation of the first active material layer 12 and the uncoated portion 18 from the side surface can be used also for recognizing the position reference and the directionality in manufacturing a laminated battery including a plurality of the batteries 1000 that are laminated. To more reliably recognize the cutting position, it is preferable to use the first active material layer 12 and the solid electrolyte layer 13 that differ in color tone from each other. In the case where the first active material layer 12 and the solid electrolyte layer 13 are visually recognizable, alignment by general image recognition is sufficiently available for recognition of the cutting position. Since many known active material layers are black in color and many solid sulfide electrolytes are materials which are bright in color such as white in color, these materials can be used. To adjust the color tones of the first active material layer 12 and the solid electrolyte layer 13, carbon, a pigment, or the like may be mixed into the layers, for example.

According to the battery manufacturing method of the present disclosure, two types of batteries having different capacities are obtained at the same time. Here, by viewing the side surfaces of the two types of batteries, it is possible to sort the two types of batteries on the basis of the amount of the first active material layer 12 without performing charge and discharge measurement of the two types of batteries. Moreover, the polarity can be distinguished also by viewing the side surface. Therefore, it is possible to reduce wrong polarity in the manufacturing process, thereby enhancing the quality.

The first active material layer 12 is disposed, for example, in contact with the first surface of the first current collector 11 to constitute the first electrode 16. The first electrode 16 is, for example, a positive electrode. In the case where the first electrode 16 is a positive electrode, the first active material layer 12 is a positive electrode active material layer. The positive electrode active material layer is a layer formed mainly of a positive electrode material such as a positive electrode active material. The positive electrode active material refers to a material that intercalates or deintercalates metal ions, such as lithium (Li) ions or magnesium (Mg) ions, in a crystal structure at a higher potential than the potential of the negative electrode and is accordingly oxidized or reduced. The positive electrode active material can be selected as appropriate depending on the battery type, and a known positive electrode active material can be used.

In the case where the battery 1000 is, for example, a lithium secondary battery, the positive electrode active material is a material that intercalates or deintercalates lithium (Li) ions and is accordingly oxidized or reduced. In this case, the positive electrode active material is, for example, a compound containing lithium and a transition metal element. The compound is, for example, an oxide containing lithium and a transition metal element or a phosphate compound containing lithium and a transition metal element. Examples of the oxide containing lithium and a transition metal element include a lithium nickel composite oxide such as LiNiₓM₁₋ₓO₂ (where M is at least one element selected from the group consisting of Co, Al, Mn, V, Cr, Mg, Ca, Ti, Zr, Nb, Mo, and W, and x satisfies 0<x≤1), a layered oxide, such as lithium cobalt oxide (LiCoO₂), lithium nickel oxide (LiNiO₂), and lithium manganese oxide (LiMn₂O₄), and lithium manganese oxide (e.g., LiMn₂O₄, Li₂MnO₃, and LiMO₂) having a spinel structure. Examples of the phosphate compound containing lithium and a transition metal element include lithium iron phosphate (LiFePO₄) having an olivine structure. Moreover, sulfur (S) or a sulfide such as lithium sulfide (Li₂S) can also be used for the positive electrode active material. In this case, positive electrode active material particles which are coated with lithium niobate (LiNbO₃) or the like or to which lithium niobate (LiNbO₃) or the like is added can be used as the positive electrode active material. The positive electrode active material may be only one of these materials or a combination of two or more of the materials.

The positive electrode active material layer should contain at least the positive electrode active material. The positive electrode active material layer may be a mixture layer formed of a mixture of the positive electrode active material and a different additive material. The different additive material can be, for example, a solid electrolyte, such as a solid inorganic electrolyte or a solid sulfide electrolyte, an electrically conductive additive such as acetylene black, or a binder, such as polyethylene oxide or polyvinylidene fluoride. By mixing the positive electrode active material with the different additive material such as a solid electrolyte in a predetermined proportion, it is possible to enhance the lithium-ion conductivity inside the positive electrode active material layer and enhance the electron conductivity inside the positive electrode active material layer.

The first active material layer 12 may have a thickness of, for example, 5 μm or more and 300 μm or less.

### (Second Active Material Layer 14)

The second active material layer 14 and the second current collector 15 constitute the second electrode 17. The second electrode 17 functions as the counter electrode of the first electrode 16. The second active material layer 14 is disposed, for example, in contact with one surface of the second current collector 15.

In FIG. 1A, the second active material layer 14 is formed by performing whole-surface coating of the second current collector 15 without providing an uncoated portion. Owing to the whole-surface coating for the second active material layer 14, it is not necessary to adjust the position reference for joining the first electrode 16 and the second electrode 17 to each other. Consequently, productivity can be enhanced and a variation factor of capacity can be reduced accordingly.

The second active material layer 14 may be formed by coating the second current collector 15 while providing an uncoated portion. By providing the uncoated portion, the second current collector 15 and the solid electrolyte layer 13 are brought into contact with each other to be joined to each other. This enhances the reliability of the laminate 2000. Therefore, it is possible to manufacture the battery 1000 having high reliability.

The second electrode 17 is configured as, for example, a negative electrode. In the case where the second electrode 17 is a negative electrode, the second active material layer 14 is a negative electrode active material layer. The negative electrode active material layer is a layer formed mainly of a negative electrode material such as a negative electrode active material. The negative electrode active material refers to a material that intercalates or deintercalates metal ions, such as lithium (Li) ions or magnesium (Mg) ions, in a crystal structure at a lower potential than the potential of the positive electrode and is accordingly oxidized or reduced. The negative electrode active material can be selected as appropriate depending on the battery type, and a known negative electrode active material can be used.

In the case where the battery 1000 is, for example, a lithium secondary battery, the negative electrode active material is a material that intercalates or deintercalates lithium (Li) ions and is accordingly oxidized or reduced. In this case, the negative electrode active material can be, for example, a carbon material, such as natural graphite, artificial graphite, a graphite carbon fiber, or resin baked carbon, or an alloy-based material to be mixed with a solid electrolyte. The alloy-based material can be, for example, a lithium alloy, such as LiAl, LiZn, Li₃Bi, Li₃Cd, Li₃Sb, Li₄Si, Li_{4.4}Pb, Li_{4.4}Sn, Li_{0.17}C, or LiC₆, an oxide of lithium and a transition metal element such as lithium titanate (Li₄Ti₅O₁₂), or a metal oxide, such as zinc oxide (ZnO) or silicon oxide (SiOₓ). The negative electrode active material may be only one of these materials or a combination of two or more of the materials.

The negative electrode active material layer should contain at least the negative electrode active material. The negative electrode active material layer may be a mixture layer formed of a mixture of the negative electrode active material and a different additive material. The different additive material can be, for example, a solid electrolyte such as a solid inorganic electrolyte or a solid sulfide electrolyte, an electrically conductive additive such as acetylene black, or a binder, such as polyethylene oxide or polyvinylidene fluoride. By mixing the negative electrode active material with the different additive material such as a solid electrolyte in a predetermined proportion, it is possible to enhance the lithium-ion conductivity inside the negative electrode active material layer and enhance the electron conductivity inside the negative electrode active material layer.

The second active material layer 14 may have a thickness of, for example, 5 μm or more and 300 μm or less.

### (Solid Electrolyte Layer 13)

The solid electrolyte layer 13 is disposed between the first active material layer 12 and the second active material layer 14. The solid electrolyte layer 13 is in contact with the first current collector 11, the first active material layer 12, and the second active material layer 14.

The solid electrolyte layer 13 may be formed by further coating the first current collector 11, on which the first active material layer 12 is formed, with the material of the solid electrolyte layer 13. The solid electrolyte layer 13 may be formed by coating the second current collector 15, on which the second active material layer 14 is formed, with the material of the solid electrolyte layer 13. In the laminate 2000, the solid electrolyte layer 13 is present also in the uncoated portion 18. In the laminate 2000 shown in FIG. 1A, the solid electrolyte layer 13 is formed in the uncoated portion 18 in a reversed pattern to the pattern of the first active material layer 12. The second active material layer 14 is formed by continuous whole-surface coating of the second current collector and furthermore the solid electrolyte layer 13 is formed by whole-surface coating of the second active material layer 14.

The solid electrolyte layer 13 contains at least a solid electrolyte. The solid electrolyte layer 13 may contain the solid electrolyte as its main component. Here, the “main component” refers to the component contained in the highest amount in mass ratio.

The solid electrolyte should be any known ionic conductive solid electrolyte for batteries. The solid electrolyte can be, for example, a solid electrolyte that conducts metal ions, such as lithium ions and magnesium ions. The solid electrolyte may be selected as appropriate depending on the conductive ionic species. The solid electrolyte can be, for example, a solid inorganic electrolyte, such as a solid sulfide electrolyte, a solid oxide electrolyte, or a solid halide electrolyte, or a solid organic polymer electrolyte.

In the present disclosure, the “solid sulfide electrolyte” refers to a solid electrolyte containing sulfur. The “solid oxide electrolyte” refers to a solid electrolyte containing oxygen. The solid oxide electrolyte may contain anions in addition to oxygen (except sulfur anions and halogen anions). The “solid halide electrolyte” refers to a solid electrolyte containing a halogen element and being free of sulfur. The solid halide electrolyte may contain oxygen in addition to the halogen element.

Examples of the solid sulfide electrolyte can include lithium-containing sulfides, such as those based on Li₂S—P₂S₅, Li₂S—SiS₂, Li₂S—B₂S₃, Li₂S—GeS₂, Li₂S—SiS₂—LiI, Li₂S—SiS₂—Li₃PO₄, Li₂S—Ge₂S₂, Li₂S—GeS₂—P₂S₅, and Li₂S—GeS₂—ZnS.

Examples of the solid oxide electrolyte can include a lithium-containing metal oxide, such as Li₂O—SiO₂ and Li₂O—SiO₂—P₂O₅, a lithium-containing metal nitride such as LiₓP_{y}O_{1-z}N_{z} (0<z≤1), lithium phosphate (Li₃PO₄), and a lithium-containing transition metal oxide such as lithium titanium oxide.

The solid halide electrolyte is, for example, a compound represented by LiₐMe_{b}Y_{c}Z₆, where the mathematic relations a+mb+3c=6 and c>0 are satisfied. Me is at least one selected from the group consisting of metalloid elements and metal elements except Li and Y. Z is at least one selected from the group consisting of F, Cl, Br, and I. The value of m represents the valence of Me.

The “metalloid elements” refer to B, Si, Ge, As, Sb, and Te. The “metal elements” are all the elements included in Groups 1 to 12 of the periodic table (except hydrogen) and all the elements included in Groups 13 to 16 of the periodic table (except B, Si, Ge, As, Sb, Te, C, N, P, O, S, and Se).

To increase the ionic conductivity of the solid halide electrolyte, Me may be at least one selected from the group consisting of Mg, Ca, Sr, Ba, Zn, Sc, Al, Ga, Bi, Zr, Hf, Ti, Sn, Ta, and Nb.

Examples of the solid halide electrolyte include Li₃YCl₆ and Li₃YBr₆.

An example of the solid organic polymer electrolyte is a compound of a polymer compound and a lithium salt. The polymer compound may have an ethylene oxide structure. The polymer compound having an ethylene oxide structure can contain a large amount of a lithium salt, and accordingly has higher ionic conductivity.

Examples of the lithium salt include LiPF₆, LiBF₄, LiSbF₆, LiAsF₆, LiSO₃CF₃, Li N(SO₂CF₃)₂, LiN(SO₂C₂F₆)₂, LiN(SO₂CF₃)(SO₂C₄F₉), and LiC(SO₂CF₃)₃. One lithium salt selected from these may be used alone. Alternatively, a mixture of two or more lithium salts selected from these may be used.

The solid electrolyte may be only one of these materials or a combination of two or more of the materials.

The solid electrolyte layer 13 may contain a binder in addition to the above solid electrolyte. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. The binder may be a copolymer. An example of the binder is a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from the above materials may be used.

The solid electrolyte layer 13 may have a thickness of 5 μm or more and 150 μm or less.

The solid electrolyte layer 13 may be constituted of an aggregate of particles of the solid electrolyte. Moreover, the solid electrolyte layer 13 may be constituted of a sintered structure of the solid electrolyte.

The first current collector 11 may have a first surface and a second surface opposite to the first surface, and the first surface faces the first active material layer 12 or the solid electrolyte layer 13. A marker as a position reference may be provided on the second surface of the first current collector 11.

The marker can be used as the position reference for cutting the laminate 2000. Moreover, the marker also can be used as the position reference for joining the first electrode 16 and the second electrode 17 in producing the laminate 2000. Consequently, it is possible to obtain a battery that is excellent in accuracy of the shape and accuracy of the capacity.

The marker may be provided in at least one selected from the group consisting of the first region 101 and the second region 102 on the second surface of the first current collector 11.

The marker may be provided in the second region 102 on the second surface of the first current collector 11. By providing the marker on the surface of the current collector outside the power generation element, it is possible to obtain a battery that is excellent in accuracy of the shape and accuracy of the capacity without influencing the battery characteristics.

No marker may be provided on the second current collector 15. Alternatively, in the case where a position reference is required, for example, to provide an uncoated portion in the second active material layer 14, a marker may be provided as in the first current collector 11.

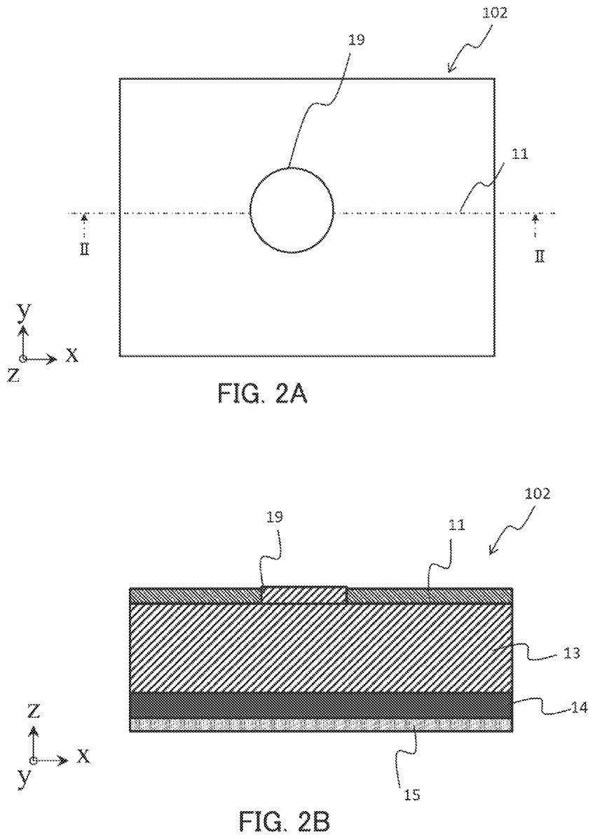

The marker may be a hole provided in the first current collector 11. FIG. 2A is an enlarged plan view showing Modification 1 of the laminate 2000 in the manufacturing method according to Embodiment 1, as viewed in the lamination direction. FIG. 2B is a cross-sectional view taken along line II-II in FIG. 2A. The laminate 2000 shown in FIG. 2A and FIG. 2B includes a marker 19 that is a hole provided in the first current collector 11.

In FIG. 2A and FIG. 2B, the marker 19 is provided in the second region 102 of the first current collector 11. Alternatively, the marker 19 may be provided in the first region 101.

The marker 19 is not limited to a particular size, and may have a diameter of, for example, 200 μm or more and 1000 μm or less. The marker 19 may be a hole having a diameter of 200 μm or more and 1000 μm or less, or may be a hole having a diameter of 300 μm.

The marker 19 may be provided by punching the current collector with a die in advance.

On the basis of the contrast between the current collector, the first active material layer 12, the second active material layer 14, and the solid electrolyte layer 13 in plan view from above in the lamination direction, the marker 19 can be recognized and used as the marker.

As shown in FIG. 2B, the solid electrolyte layer 13 enters the marker 19 to be fixed to the side wall of the marker 19. This fixing action unifies the first current collector 11 and the solid electrolyte layer 13 more strongly. This suppresses delamination caused by expansion and contraction resulting from repetition of charge and discharge and the thermal cycle.

According to such a configuration, it is possible to obtain a highly reliable battery with high accuracy of the capacity.

The marker 19 may be provided so as to be positioned in a corner region of the battery 1000 to be obtained, where the marker 19 easily becomes separated. This further suppresses delamination caused by expansion and contraction resulting from repetition of charge and discharge and the thermal cycle.

According to the above configuration, since no protrusion is provided on the surface of the first current collector 11, a conveying method using the suction pad can be introduced into the manufacturing process. Consequently, it is possible to manufacture a battery with excellent mass productivity without causing scratches on the first current collector 11.

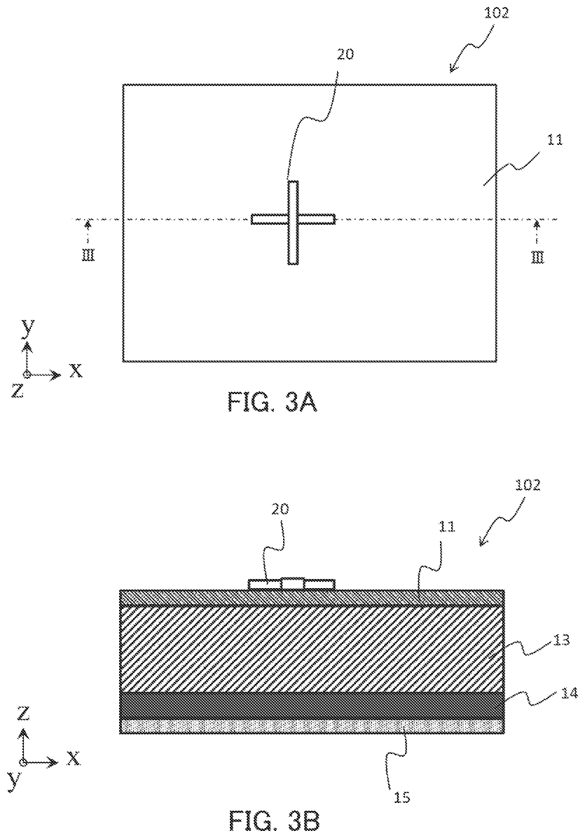

The marker may be a coating provided on the second surface of the first current collector 11. FIG. 3A is an enlarged plan view showing Modification 2 of the laminate 2000 in the manufacturing method according to Embodiment 1, as viewed in the lamination direction. FIG. 3B is a cross-sectional view taken along line III-Ill in FIG. 3A. The laminate 2000 shown in FIG. 3A and FIG. 3B includes a marker 20 obtained by coating the second surface of the first current collector 11.

FIG. 3A shows an example in which the marker 20 is cross-shaped. However, the marker 20 is not limited to any particular shape as long as the marker 20 can be used as the position reference.

The marker 20 may be formed, for example, by performing in advance pattern printing of a paste of the same solid electrolyte as that of the solid electrolyte layer 13 on the current collector. In this case, the marker 20 having any shape can be formed. Consequently, it is possible to support various recognition alignment methods and environments, thereby obtaining a battery that is excellent in accuracy of the shape and accuracy of the capacity.

The marker 20 may have, for example, a shape obtained by crossing pieces of the above paste each having a line length of 500 μm, a line width of 100 μm, and a thickness of 10 μm. Such a configuration facilitates correction of angle deviation in the joining or the cutting.

The marker 20 may be formed by using a binder component or a solid electrolyte having high plasticity. In this case, for example, when a plurality of the batteries 1000 obtained by the manufacturing method according to Embodiment 1 are laminated to form a multilayer, the marker 20 acts as the adhesive for adhering the laminated unit batteries to each other. Consequently, the structure of the laminated battery can be further reinforced.

Even with the above configuration, it is possible to obtain a highly reliable battery with high accuracy of the capacity.

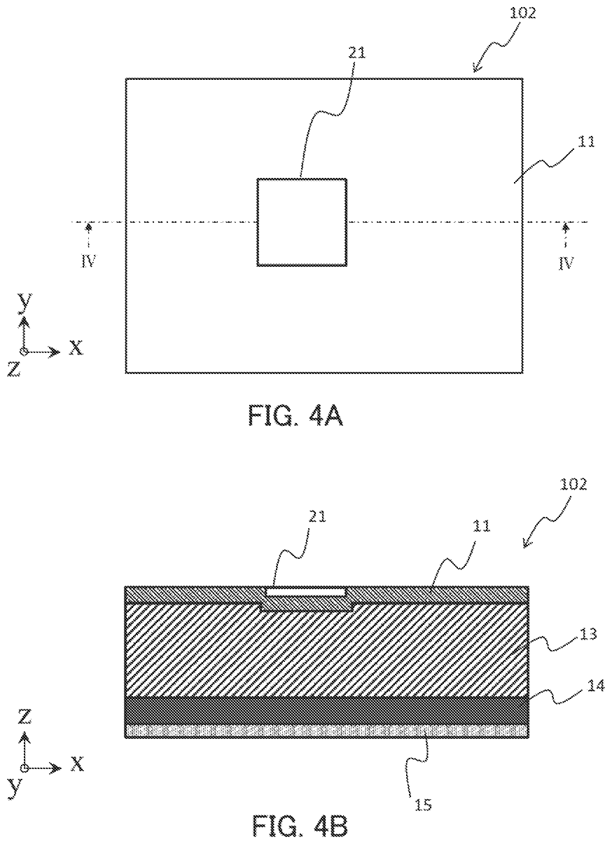

The marker may be a recess provided in the second surface of the first current collector 11. FIG. 4A is an enlarged plan view showing Modification 3 of the laminate 2000 in the manufacturing method according to Embodiment 1, as viewed in the lamination direction. FIG. 4B is a cross-sectional view taken along line IV-IV in FIG. 4A. The laminate 2000 shown in FIG. 4A and FIG. 4B includes a marker 21 that is a recess provided in the second surface of the first current collector 11.

According to such a configuration, since no protrusion is provided on the surface of the first current collector 11, a conveying method using the suction pad can be introduced into the manufacturing process. Consequently, it is possible to manufacture a battery with excellent mass productivity without causing scratches on the first current collector 11.

As shown in FIG. 4B, the marker 21 may be a recess provided in the second surface of the first current collector 11 so that a protrusion corresponding to the recess is provided on the first surface of the first current collector 11.

In the laminate 2000 including the first current collector 11 in which the marker 21 as above is provided, the portion in which the marker 21 is provided is smaller than the portion in which the marker 21 is not provided in terms of the distance between the first current collector 11 and the second current collector 15 by the protrusion provided on the first surface of the first current collector 11. This increases, between the first current collector 11 and the second current collector 15, the density of the solid electrolyte layer 13, the first active material layer 12, and the second active material layer 14, thereby increasing the hardness. Moreover, the first current collector 11 is strongly joined to the first active material layer 12 and the solid electrolyte layer 13, which are in contact with the first surface, thereby suppressing separation of the first current collector 11 due to the stress caused by charge and discharge or the thermal cycle. Therefore, the laminate 2000 having higher reliability is obtained, and the battery 1000 having reliability can be manufactured accordingly. In particular, this effect becomes apparent in manufacturing a thinned battery.

The marker 21 is not limited to a particular shape. The marker 21 may be a recess having a rectangular or circular shape.

The marker 21 may be, for example, a recess having a 500-μm square shape and a depth of 3 μm to 5 μm.

The marker 21 may be formed by pressing or denting the current collector with a die in advance.

The marker 21 may be a recess that is formed in the surface of the current collector by providing a hole in at least one selected from the group consisting of the first active material layer 12, the solid electrolyte layer 13, and the second active material layer 14. For example, the marker 21 may be a recess that is formed in the surface of the first current collector 11 by providing a hole in the first active material layer 12. In the case where a hole is provided in at least one selected from the group consisting of the first active material layer 12, the solid electrolyte layer 13, and the second active material layer 14, the joining strength is enhanced by the first current collector 11 and the relevant layers digging into the hole.

According to the above configuration, it is possible to manufacture a further highly reliable battery with higher accuracy of the capacity.

The cutting the laminate 2000 in the above (A) may be performed in a state where the side surface of the laminate 2000 along the lengthwise direction is observed.

As described above, the first active material layer 12 and the solid electrolyte layer 13 can be distinguished from each other by their color tones. Moreover, assume, for example, a case where the solid electrolyte layer 13 is formed of a material, such as a solid sulfide electrolyte, having higher plasticity than the active material has. In this case, in the pressing in the manufacturing process of the laminate 2000, the second region 102 is compressed as compared with the first region 101, and thus its compression proceeds by, for example, 30% to 40% in the lamination direction. Consequently, the second region 102 has a thickness smaller than the first region 101 has. Even from this difference, the second region 102 can be distinguished by observing the appearance of the side surface of the laminate 2000 along the lengthwise direction. Therefore, by performing the cutting the laminate 2000 in the above (A) in a state where the side surface of the laminate 2000 along the lengthwise direction is observed, the cutting position can be confirmed from the appearance of the side surface even when the marker is not provided on the second surface of the first current collector 11.

According to the above configuration, it is possible to manufacture a battery that is excellent in accuracy of the shape and accuracy of the capacity without influencing the battery characteristics. Moreover, since no unevenness is imparted to the surface of the battery, a conveying method using the suction pad can be introduced into the manufacturing process. Consequently, it is possible to manufacture a battery with excellent mass productivity without causing scratches on the current collector.

### Embodiment 2

A battery according to Embodiment 2 will be described below. The description of the matters common to the above embodiment will be omitted as appropriate.

The battery according to Embodiment 2 includes a first current collector, a first active material layer, a solid electrolyte layer, and a second active material layer in this order. The side surface of the battery includes a first side surface and a second side surface opposite to the first side surface, where the first active material layer is exposed on the first side surface and is not exposed on the second side surface. The second side surface is smaller than the first side surface in terms of the sum of the thicknesses of the first current collector, the first active material layer, the solid electrolyte layer, and the second active material layer.

The battery according to Embodiment 2 may further include a second current collector, wherein the first active material layer, the solid electrolyte layer, and the second active material layer may be disposed between the first current collector and the second current collector, and the second side surface may be smaller than the first side surface in terms of the sum of the thicknesses of the first current collector, the first active material layer, the solid electrolyte layer, the second active material layer, and the second current collector.

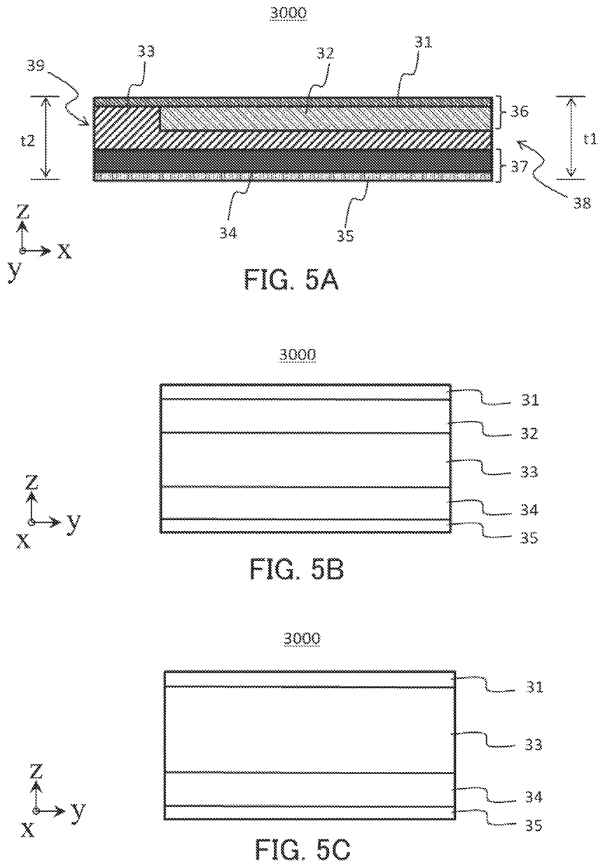

FIG. 5A is a schematic cross-sectional view showing the configuration of a battery 3000 according to Embodiment 2, as viewed in the lengthwise direction.

The battery 3000 shown in FIG. 5A includes a first electrode 36, a solid electrolyte layer 33, and a second electrode 37. The first electrode 36 consists of a first current collector 31 and a first active material layer 32. The second electrode 37 consists of a second current collector 35 and a second active material layer 34.

Accordingly, the battery 3000 includes the first current collector 31, the first active material layer 32, the solid electrolyte layer 33, the second active material layer 34, and the second current collector 35 that are laminated in this order. The solid electrolyte layer 33 is disposed in contact with the first active material layer 32 and the second active material layer 34. The side surface of the battery 3000 has a first side surface 38 and a second side surface 39 opposite to the first side surface 38, where the first active material layer 32 is exposed on the first side surface 38 and is not exposed on the second side surface 39. The second side surface 39 is smaller than the first side surface 38 in terms of the sum of the thicknesses of the first current collector 31, the first active material layer 32, the solid electrolyte layer 33, and the second active material layer 34. That is, in the battery 3000 shown in FIG. 5A, a thickness t2 of the second side surface 39 of the battery 3000 is smaller than a thickness t1 of the first side surface 38 of the battery 3000. FIG. is a side view showing the first side surface 38 of the battery 3000 according to Embodiment 2. FIG. 5C is a side view showing the second side surface 39 of the battery 3000 according to Embodiment 2.

In the battery having such a configuration, when the layers are laminated and unified by pressurization in the manufacturing, stronger compression of the solid electrolyte layer 33 is performed on the side of the second side surface 39 on which the first active material layer 32 is not exposed, thereby increasing the strength. Furthermore, the first current collector 31 and the solid electrolyte layer 33 are strongly joined to each other, and consequently the first current collector 31 is less prone to separate, thereby enhancing the battery characteristics and the reliability.

In the battery 3000 according to Embodiment 2, the second active material layer 34 may be exposed on at least one selected from the group consisting of the first side surface 38 and the second side surface 39, or the second active material layer 34 may be exposed on the first side surface 38. As shown in FIG. 5A, FIG. 5B, and FIG. 5C, in the battery 3000, the second active material layer 34 may be exposed on the first side surface 38 and the second side surface 39.

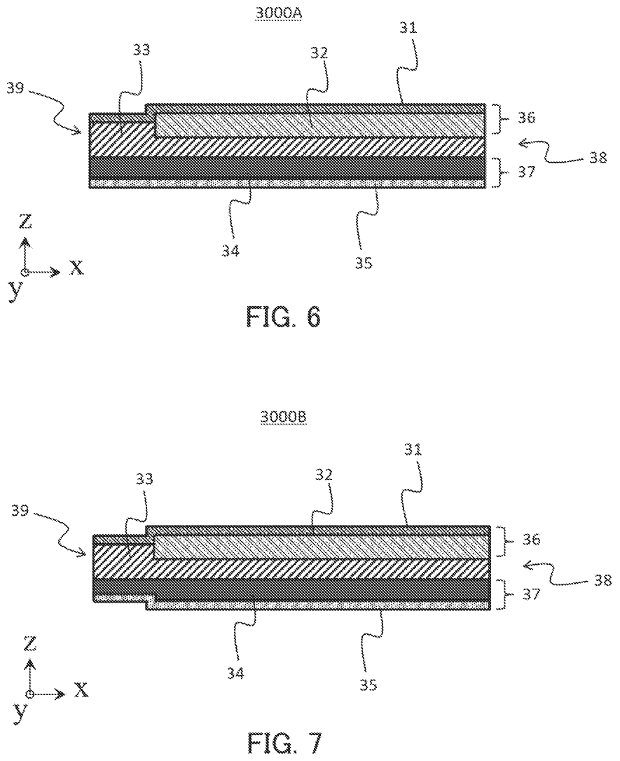

FIG. 6 is a cross-sectional view showing a battery 3000A according to Modification 1 of the battery 3000 according to Embodiment 2, as viewed in the lengthwise direction.

The battery 3000A according to Modification 1 includes the first current collector 31. As shown in FIG. 6, in the battery 3000A, the first current collector 31 has the second surface that is recessed in the vicinity of the second side surface 39. That is, in the battery 3000A, the second side surface 39 is smaller than the first side surface 38 in terms of the sum of the thicknesses of the first current collector 31, the first active material layer 32, the solid electrolyte layer 33, the second active material layer 34. Note that FIG. 6 shows a configuration example in which the first current collector 31 has the second surface that is recessed in the vicinity of the second side surface 39 and the first surface that protrudes toward the solid electrolyte layer 33 to correspond to the recess. Moreover, in the battery 3000A, the second side surface 39 is smaller than the first side surface 38 in terms of the sum of the thicknesses of the first current collector 31, the first active material layer 32, the solid electrolyte layer 33, the second active material layer 34, and the second current collector 35.

In the battery 3000 according to Embodiment 2, the principal surface of the region where the first active material layer 32 is not present in plan view in the lamination direction may be recessed. As shown in FIG. 6, in the battery 3000 according to Embodiment 2, the second surface of the first current collector 31 in the region where the first active material layer 32 is not present in plan view in the lamination direction may be recessed so that the first surface of the first current collector 31 protrudes toward the solid electrolyte layer 33 to correspond to the recess. As shown in FIG. 6, in the battery 3000 according to Embodiment 2, at least a portion of the side surface of the first active material layer 32 close to the second side surface 39 may be coated with the first current collector 31. In the battery 3000 according to Embodiment 2, the side surface of the first active material layer 32 close to the second side surface 39 may be coated with the first current collector 31 and the solid electrolyte layer 33. That is, the second side surface 39 on which the first active material layer 32 is not exposed may be formed by coating the side surface of the first active material layer 32 with the first current collector 31 and the solid electrolyte layer 33.

FIG. 7 is a cross-sectional view showing a battery 3000B according to Modification 2 of the battery 3000 according to Embodiment 2, as viewed in the lengthwise direction.

The battery 3000B according to Modification 2 includes the first current collector 31 and the second current collector 35. In the battery 3000B, at least one selected from the group consisting of the first current collector 31 and the second current collector 35 may have the second surface that is recessed in the vicinity of the second side surface 39. Note that FIG. 7 shows a configuration example in which the first current collector 31 and the second current collector 35 each have the second surface that is recessed in the vicinity of the second side surface 39 and the first surface that protrudes toward the solid electrolyte layer 33 to correspond to the recess. In the battery 3000B, the second side surface 39 is smaller than the first side surface 38 in terms of the sum of the thicknesses of the first current collector 31, the first active material layer 32, the solid electrolyte layer 33, the second active material layer 34, and the second current collector 35.

The second side surface 39 may be smaller than the first side surface 38 in terms of the sum of the thicknesses of the first current collector 31, the first active material layer 32, the solid electrolyte layer 33, the second active material layer 34, and the second current collector 35 by the range of 5% or more and 20% or less.

In this case, the first current collector 31, the first active material layer 32, the solid electrolyte layer 33, the second active material layer 34, and the second current collector 35 are increased in density in the vicinity of the second side surface 39, thereby increasing the mechanical strength. Furthermore, the solid electrolyte layer 33 and the first current collector 31 are strongly joined to each other, and consequently the first current collector 31 is less prone to separate. Therefore, it is possible to obtain a battery having high reliability and a reduced structural defect resulting from temperature variations due to the thermal cycle or the like during use of the battery.

At least one selected from the group consisting of the first side surface 38 and the second side surface 39 may be a flat surface defined by the respective edge faces of the layers constituting the battery 3000. The flat surface may be, for example, a single cut surface obtained by a single cut. The first side surface 38 and the second side surface 39 each may be a flat surface defined by the respective edge faces of the layers constituting the battery 3000.

The battery 3000 according to Embodiment 2 can be manufactured, for example, by the manufacturing method according to Embodiment 1.

The respective materials to be used for the first current collector 31, the first active material layer 32, the solid electrolyte layer 33, the second active material layer 34, the second current collector 35, the first electrode 36, and the second electrode 37 in the battery 3000 correspond to the materials to be used for the first current collector 11, the first active material layer 12, the solid electrolyte layer 13, the second active material layer 14, the second current collector 15, the first electrode 16, and the second electrode 17 in the manufacturing method according to Embodiment 1.

### Embodiment 3

A battery according to Embodiment 3 will be described below. The description of the matters common to the above embodiments will be omitted as appropriate.

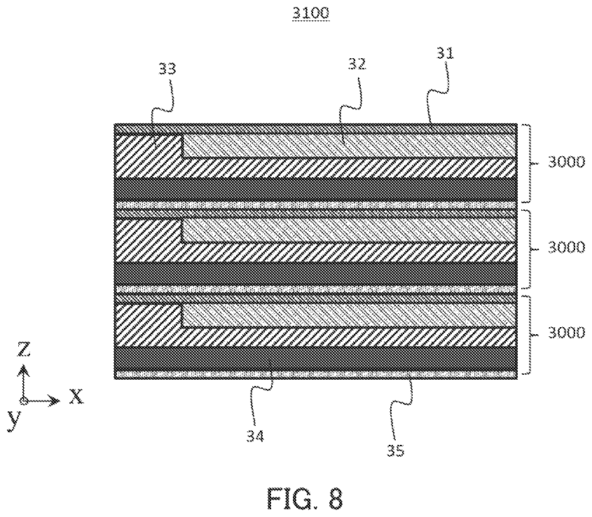

FIG. 8 is a schematic cross-sectional view showing the configuration of a laminated battery 3100 according to Embodiment 3. The laminated battery 3100 includes a plurality of the batteries 3000 according to Embodiment 2. In the laminated battery 3100, the plurality of batteries 3000 according to Embodiment 2 are laminated on top of one another in the thickness direction of the battery 3000. The laminated battery 3100 is a series battery composed of the plurality of batteries 3000 according to Embodiment 2 that are laminated. The batteries 3000 each may be joined to the adjacent battery 3000 with an electrically conductive resin.

The laminated battery 3100 shown in FIG. 8 is a battery composed of the three batteries 3000 that are laminated. However, the number of the batteries 3000 to be laminated is not limited to this. The laminated battery 3100 may be a battery composed of the two batteries 3000 that are laminated, or may be a battery composed of the four or more batteries 3000 that are laminated.

According to such a configuration, it is possible to obtain a highly reliable battery having high energy.

### Embodiment 4

A battery according to Embodiment 4 will be described below. The description of the matters common to the above embodiment will be omitted as appropriate.

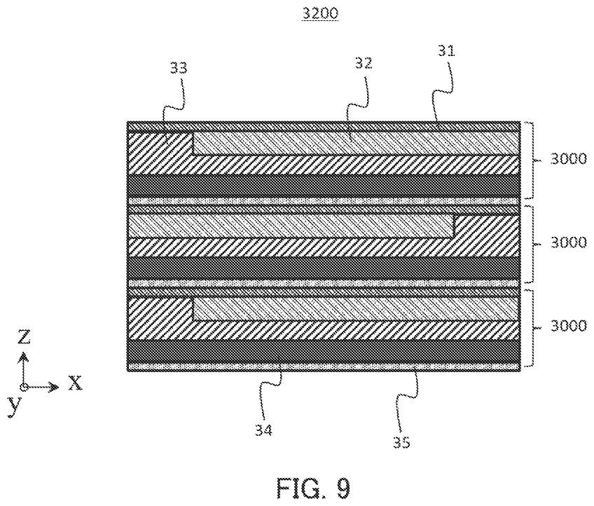

FIG. 9 is a schematic cross-sectional view showing the configuration of a laminated battery 3200 according to Embodiment 4. The laminated battery 3200 is a modification of the laminated battery 3100 according to Embodiment 3. In the laminated battery 3200 shown in FIG. 9, the plurality of batteries 3000 including two adjacent batteries, namely, a first battery and a second battery, may be laminated so that the first battery and the second battery are reversed to each other in terms of the orientations of the first side surface 38 and the second side surface 39.

Batteries generally have directionality of bias in coating amount, density, etc. caused in the coating or lamination process in the battery manufacturing process. In the case where the batteries 3000 are laminated so that the adjacent batteries are reversed to each other in terms of the orientations of the first side surface 38 and the second side surface 39 as above, the distribution (bias) in coating amount, density, etc. of the active material of the batteries 3000 is dispersed in the laminated battery 3200. This suppresses the occurrence of a structural defect of the laminated battery 3200 caused by expansion and contraction of the batteries 3000 resulting from charge and discharge or the thermal cycle. Therefore, it is possible to obtain a battery having high reliability, high capacity, and high energy.

### [Battery Manufacturing Method]

Next, an example of the battery manufacturing method of the present disclosure will be described.

First, pastes are produced that are to be used for forming the first active material layer 12 (hereinafter, referred to as a positive electrode active material layer) and the second active material layer 14 (hereinafter, referred to as a negative electrode active material layer) by printing. A solid electrolyte raw material to be prepared for use as a mixture of each of the positive electrode active material layer and the negative electrode active material layer is, for example, a Li₂S—P₂S₅-based sulfide glass powder having an average particle diameter of about 10 μm and containing triclinic crystals as its main component. The glass powder can be a glass powder having a high ionic conductivity (e.g., 2×10⁻³ S/cm to 3×10⁻³ S/cm). The positive electrode active material to be used is, for example, a Li·Ni·Co·Al composite oxide (e.g., LiNi_{0.8}Co_{0.15}Al_{0.05}O₂) powder having an average particle diameter of about 5 μm and a layered structure. A mixture containing the above positive electrode active material and the above glass powder is dispersed in an organic solvent or the like to produce a positive electrode active material layer paste. Moreover, the negative electrode active material to be used is, for example, a natural graphite powder having an average particle diameter of about 10 μm. A mixture containing the above negative electrode active material and the above glass powder is dispersed in an organic solvent or the like to produce a negative electrode active material layer paste.

Subsequently, the first current collector 11 (hereinafter, referred to as a positive electrode current collector) and the second current collector 15 (hereinafter, referred to as a negative electrode current collector) to be prepared are each, for example, a rolled copper foil having a thickness of about 30 μm.

Subsequently, continuous coating of one surface of the copper foil, which is the positive electrode current collector, with the positive electrode active material layer paste is performed with a die coater a plurality of batteries while interposing the uncoated portion 18 between the coated portions so that the portion of the applied positive electrode active material layer paste has a predetermined shape and a thickness in an approximate range of 50 μm to 100 μm. Here, the continuous coating is performed so that the length of the portion of the applied positive electrode active material layer paste and the uncoated portion 18 that are continuous in the coating direction is twice the length of the unit battery. Moreover, in the same manner as in the positive electrode active material layer paste, one surface of the other copper foil is coated with the negative electrode active material layer paste with a die coater while interposing the uncoated portion between the coated portions so that the portion of the applied positive electrode active material layer paste has a predetermined shape and a thickness in an approximate range of 50 μm to 100 μm. Thereafter, the portions of the applied positive electrode active material layer paste and the portions of the applied negative electrode active material layer paste are each dried by blowing air at 80° C. to 130° C. and thus to have a thickness of 30 μm to 60 μm. Thus, a positive electrode current collector including a positive electrode active material layer and having the first region 101 and the second region 102 that are repeated alternately is obtained, where the positive electrode active material layer is present in the first region 101 and is not present in the second region 102 in plan view. Moreover, a negative electrode current collector including a negative electrode active material layer and having a coating pattern similar to the coating pattern of the positive electrode active material layer is obtained. That is, a positive electrode and a negative electrode are obtained.

Subsequently, the above glass powder is dispersed in an organic solvent or the like to produce a solid electrolyte layer paste. The above solid electrolyte layer paste is printed on the positive electrode active material layer and the uncoated portion 18 with a die coater so as to have a thickness in, for example, an approximate range of 100 μm to 200 μm. Moreover, the above solid electrolyte layer paste is printed on the negative electrode active material layer and the uncoated portion with a die coater so as to have a thickness in, for example, an approximate range of 100 μm to 200 μm. Thereafter, the paste is dried by blowing air at 80° C. to 130° C.

Subsequently, the solid electrolyte printed on the positive electrode active material layer and the solid electrolyte printed on the negative electrode active material layer are opposed to each other and continuously joined to each other by roll pressing at a pressure equivalent to 1 t/cm² to 3 t/cm² at about 70° C. Thus, a laminate is obtained in which the negative electrode current collector, the negative electrode active material layer, the solid electrolyte layer 13, the positive electrode active material layer, and the positive electrode current collector are laminated in this order. Here, the joining performed in a state where the positive electrode active material layer and the uncoated portion 18 respectively overlap with the negative electrode active material layer and the uncoated portion. Then, only the solid electrolyte layer 13 is present between the positive electrode current collector and the negative electrode current collector in the second region 102. Thus, the laminate 2000 is obtained.

Subsequently, the laminate 2000 is cut in the lamination direction in the first region 101 and the second region 102 to obtain a battery. By successively cutting at the same position in each of the first regions 101 and the second regions 102, it is possible to obtain one battery having a target capacity and another battery having the same length as the length of the one battery and a different capacity from the capacity of the one battery.

The battery obtained by cutting the laminate is subjected to evaluation of charge and discharge characteristics to measure the capacity, and the measured capacity is compared with a desired capacity. From the results, a more precise cutting position at which a battery having a desired capacity is obtained is determined. By cutting at the position thus determined, it is possible to achieve higher accuracy of the capacity.

In the battery thus obtained, the negative electrode current collector, the negative electrode active material layer, the solid electrolyte layer, the positive electrode active material layer, and the positive electrode current collector are laminated in this order. The side surface of the battery includes a first side surface and a second side surface opposite to the first side surface, where the positive electrode active material layer is exposed on the first side surface and is not exposed on the second side surface.

As described above, by using the manufacturing method according to the present disclosure, it is possible to manufacture a battery with high accuracy of the capacity. Moreover, by using the battery manufacturing method of the present disclosure, it is also possible to obtain two types of batteries having the same length and different capacities.

While the battery of the present disclosure has been described on the basis of the embodiments, the present disclosure is not limited to the embodiments. Various modifications of the embodiments conceivable by those skilled in the art and other embodiments achieved by combining some of the constituent elements of the embodiments also fall within the scope of the present disclosure without departing from the spirit of the present disclosure.

### INDUSTRIAL APPLICABILITY

The battery according to the present disclosure can be used, for example, as a secondary battery such as an all-solid-state battery for use in various electronic devices, automobiles, and the like.

What is claimed is:

1. A battery manufacturing method comprising
(A) obtaining a battery by cutting a long laminate in a lamination direction, the laminate including a first active material layer, a solid electrolyte layer, and a second active material layer that are disposed in this order, wherein
the laminate has a first region and a second region that are repeated alternately in a lengthwise direction, where the first active material layer is present in the first region and is not present in the second region in plan view in the lamination direction, and
in the (A), the laminate is cut in the first region and the second region so that the battery has a desired capacity.

2. The manufacturing method according to claim 1, further comprising:
(B) measuring a capacity of the battery obtained in the (A); and
(C) determining a cutting position of the laminate by comparing the capacity measured in the (B) with the desired capacity.

3. The manufacturing method according to claim 1, wherein
an area of the first region in plan view in the lamination direction has linearity in the lengthwise direction.

4. The manufacturing method according to claim 1, wherein
the battery includes at least a battery A and a battery B, and
the battery A and the battery B have the same length and different capacities.

5. The manufacturing method according to claim 1, wherein
a sum of lengths of the first region and the second region continuous with the first region in the lengthwise direction is twice a length of the battery.

6. The manufacturing method according to claim 1, wherein
the laminate further includes a current collector,
in the first region, the first active material layer is disposed between the current collector and the solid electrolyte layer, and
in the second region, the solid electrolyte layer is disposed between the current collector and the second active material layer.

7. The manufacturing method according to claim 6, wherein
the current collector has a first surface and a second surface opposite to the first surface, the first surface facing the first active material layer or the solid electrolyte layer, and
the second surface of the current collector has an uneven structure.

8. The manufacturing method according to claim 6, wherein
the current collector has a first surface and a second surface opposite to the first surface, the first surface facing the first active material layer or the solid electrolyte layer, and
a marker as a position reference is provided on the second surface of the current collector.

9. The manufacturing method according to claim 8, wherein
the marker is provided in the second region.

10. The manufacturing method according to claim 8, wherein
the marker is a coating provided on the second surface of the current collector.

11. The manufacturing method according to claim 8, wherein
the marker is a recess provided in the second surface of the current collector.

12. The manufacturing method according to claim 8, wherein
the marker is a hole provided in the current collector.

13. The manufacturing method according to claim 1, wherein
the cutting the laminate in the (A) is performed in a state where a side surface of the laminate along a lengthwise direction is observed.

14. A battery comprising, in the following order:
a first current collector;
a first active material layer;
a solid electrolyte layer; and
a second active material layer, wherein
a side surface of the battery includes a first side surface and a second side surface opposite to the first side surface, where the first active material layer is exposed on the first side surface and is not exposed on the second side surface, and
the second side surface is smaller than the first side surface in terms of a sum of thicknesses of the first current collector, the first active material layer, the solid electrolyte layer, and the second active material layer.

15. The battery according to claim 14, further comprising
a second current collector, wherein
the first active material layer, the solid electrolyte layer, and the second active material layer are disposed between the first current collector and the second current collector, and
the second side surface is smaller than the first side surface in terms of a sum of thicknesses of the first current collector, the first active material layer, the solid electrolyte layer, the second active material layer, and the second current collector.

16. A laminated battery comprising
a plurality of the batteries according to claim 14, wherein
the plurality of batteries are laminated in a thickness direction of the battery.

17. The laminated battery according to claim 16, wherein
the plurality of batteries including a first battery and a second battery adjacent to each other are laminated so that the first battery and the second battery are reversed to each other in terms of orientations of the first side surface and the second side surface.
